(19) United States
(12) Patent Application Publication
(10) Pub. No.: US 2012/0105218 A1
(43) Pub. Date: May 3, 2012

(54) SEATBELT ALERT LIGHTING SYSTEM AND METHOD

(76) Inventor: James Robert Scanapico, West Islip, NY (US)

(21) Appl. No.: 13/284,363

(22) Filed: Oct. 28, 2011

Related U.S. Application Data
(60) Provisional application No. 61/408,003, filed on Oct. 29, 2010.

(51) Int. Cl. B60Q 1/00

(52) U.S. Cl. 340/425.5

(57) ABSTRACT

The present disclosure provides a system and method for providing seatbelt alert warnings to observers outside of a vehicle, such as law enforcement personnel. A signal responsive to the disengagement of the seatbelt is generated. Responsive to the signal, a source of illumination is switched from a deactivated mode to an activated mode in which the source of illumination generates an indicator readily visible to the outside observer. Based on the readily visible indicator, the observer can determine whether one or more occupants of the vehicle have properly worn the seatbelt(s).

### FIELD OF THE DISCLOSURE

The present disclosure generally relates to an alert lighting system and method, and more particularly, to an alert lighting system retrofittable to a vehicle, which automatically activates one or more indicator lights associated with the vehicle under circumstances of a seatbelt not being properly fastened.

### BACKGROUND

Seatbelts are widely applied to a variety of motor vehicles to secure occupants of the vehicles against harmful movement that may result from a collision or a sudden stop. In more than 40 states of the United Sates, the state legislature requires that the driver's seatbelt must be worn when the vehicle is in operation. When law enforcement personnel find that an occupant (a driver or a passenger) is not wearing his/her seatbelt while the vehicle is in operation, the law enforcement personnel normally pull over the vehicle and give the driver a warning or a ticket.

However, it is difficult for the law enforcement personnel to visually discern whether the occupant is properly wearing his/her seatbelt when the vehicle is moving at a high speed. Thus, in many cases, the vehicle in which an occupant does not wear his/her seatbelt is not stopped by the law enforcement personnel, which imposes significant danger to the occupant and/or other motorists. Furthermore, without a positive determination that the occupant is not wearing his/her seatbelt, the law enforcement personnel lack basis to stop the vehicle.

Therefore, the applicant has recognized that it is desirable to develop an alert lighting system and method used in motor vehicles, which provide readily visible indications that the driver or an occupant is not wearing a seatbelt to law enforcement personnel, motorists and pedestrians, such that actions can be taken to stop the vehicles and avoid potential injuries and even fatalities of the vehicle occupants.

### SUMMARY

According to one aspect of the present disclosure, a seatbelt alert lighting system used with a vehicle having a seatbelt is provided. The system includes a seatbelt engagement switch configured to generate a first signal responsive to the disengagement of the seatbelt and a second signal responsive to the engagement of the seatbelt. The system further includes at least one source of illumination in communication with the seatbelt engagement switch. The source of illumination has an activated mode and a deactivated mode. In the activated mode, the source of illumination generates an indicator readily visible to an observer outside of the vehicle. The at least one source of illumination is configured to switch from the deactivated mode to the activated mode responsive to the first signal.

According to another aspect of the present disclosure, a method of indicating disengagement of a seatbelt in a vehicle is provided. The method includes generating a first signal responsive to the disengagement of the seatbelt; switching at least one source of illumination from a deactivated mode to an activated mode for generating an indicator readily visible to an observer outside of the vehicle responsive to the first signal; and displaying the indicator to the observer outside of the vehicle.

### BRIEF DESCRIPTION OF THE DRAWINGS

The foregoing objects and advantages of the present disclosure may be more readily understood by one skilled in the art with reference to the following detailed description of several embodiments thereof, taken in conjunction with the accompanying drawings wherein like elements are designated by identical reference numerals throughout the several views, and in which:

FIG. 1 is a schematic diagram showing a seatbelt alert lighting system according to an embodiment of the present invention;

FIG. 2 is a block diagram showing a seatbelt alert lighting system according to another embodiment of the present invention;

FIGS. 3A-3D are schematic views showing various positions available for mounting the seatbelt alert lighting system; and

FIG. 4 is a flowchart illustrating a method for indicating disengagement of a seatbelt in a vehicle, according to another aspect of the present invention.

### DETAILED DESCRIPTION

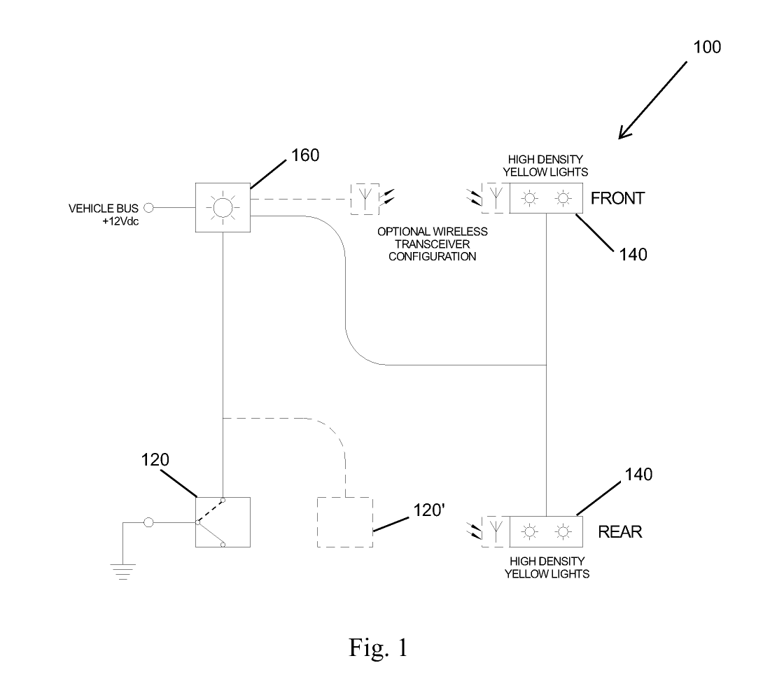

FIG. 1 shows a seatbelt alert lighting system 100 according to an embodiment of the present invention. The seatbelt alert lighting system 100 is used with a motor vehicle having a seatbelt.

The system 100 includes a seatbelt engagement switch 120, which is configured to generate a first signal responsive to the disengagement of the seatbelt and a second signal responsive to the engagement of the seatbelt. The seatbelt engagement switch 120 can be any suitable switch used in a motor vehicle for indicating engagement or disengagement of the seatbelt. For example, when the metal tab of the seatbelt is properly positioned within a corresponding receptacle mounted on a seat of the vehicle, the seatbelt switch 120 generates a first signal indicative of the proper positioning of the metal tab, i.e., engagement of the seatbelt. When the metal tab of the seatbelt is not properly positioned within the receptacle after the motor vehicle is operated, the seatbelt switch 120 generates a second signal indicative of improper positioning of the metal tab, i.e., disengagement of the seatbelt.

Both the first and second signal include, but are not limited to, analogue signals, such as a high voltage level or a low voltage level, and digital signals. Both the first signal and the second signal can be transmitted through a wireless or wired connection. In addition, the seatbelt engagement switch 120 can be a mechanical switch having a first operative position actuated by disengaging the metal tab from the receptacle, at which the first signal is generated, and a second operative position actuated by inserting the metal tab within the receptacle, at which the second signal is generated, as shown in FIG. 1. Alternatively or additionally, the seatbelt engagement switch can include an electrical switch, which detects the position of the metal tab and generates signals accordingly.

The motor vehicle typically includes a plurality of seatbelts, such as a seatbelt for the driver, a seatbelt for the front row passenger and a seatbelt for each of the passengers in the rear row(s). Accordingly, the system 100 can include a plurality of seatbelt engagement switches, each corresponding to a predetermined seatbelt. Although the system 100 according to the exemplary embodiments of the present invention will be described with respect to the driver's seatbelt and its associated seatbelt engagement switch, a person of ordinary skill in the art understands that the system 100 is equally applicable to other seatbelts, without limiting the type, location and number of the seatbelts.

The system 100 further includes at least one source of illumination 140 in communication with the seatbelt engagement switch 120. The source of illumination 140 has an activated mode and a deactivated mode, which can be switched between one another. In the activated mode, the source of illumination 140 generates an indicator readily visible to observers outside of the vehicle, such as other motorists, pedestrians and law enforcement personnel. The source of illumination 140 is configured to switch from the deactivated mode to the activated mode responsive to the first signal generated by the seatbelt engagement switch 120. Thus, if the seatbelt is not properly engaged in its corresponding receptacle (i.e., disengagement of the seatbelt), an indicator will be generated and displayed to alert the observers outside of the vehicle, that one or more occupants of the vehicle in operation are not in compliance with local and state seatbelt safety law or regulations and accordingly represent a danger to both themselves and others in the event of a potential collision or other accident. Further, the source of illumination 140 is configured to switch from the activated mode to the deactivated mode position, responsive to the second signal generated by the seatbelt engagement switch 120. Thus, once the seatbelt is properly deployed (i.e., engagement of the seatbelt), the indicator is no longer displayed.

The source of illumination includes, but is not limited to, one or more of a lamp, an LED, a strobe, an incandescent light and a halogen light. The source of illumination can be any suitable source wired into the existing interior seatbelt utilization arrangement of the vehicle. For example, the source of illumination can be wired, in a retrofittable manner, with a seatbelt warning light 160 disposed on the dashboard of the vehicle, which is not readily visible to outside observers and is not capable of providing positive indication to the observers for determining whether all the occupants have properly worn their seatbelts. For example, the sources of illumination 140 can be powered by a 12-volt lighting circuit, which is typically installed in the vehicle as a part of the lighting and electrical system of the vehicle.

The seatbelt warning light 160 disposed on the dashboard can be incorporated into the seatbelt alert lighting system according to the present invention to serve as a readily visible indicator to observers inside of the vehicle, such as the occupants of the vehicle.

Furthermore, as may be desired by a particular vehicle manufacturer in conformance with the aesthetic appearance of the vehicle, the shape and profile of the source of illumination can be round, square, rectangular, oval, diamond shaped, triangular or of any suitable geometric shape. The indicator generated by the source of illumination can be consistent with the shape and profile of the source. Alternatively or additionally, the indicator can be of a bar, a strip or flickering dots; the indicator can further include a lighted sign including a text, symbol or diagram representative of an indication that the seatbelts have not been properly deployed by the driver and/or passengers.

Furthermore, the color of the illumination or the indicator includes, but is not limited to, a clear white light, amber, red, blue, green or any color combinations which are approved by various federal and state regulations and are consistent with current automotive industry standards.

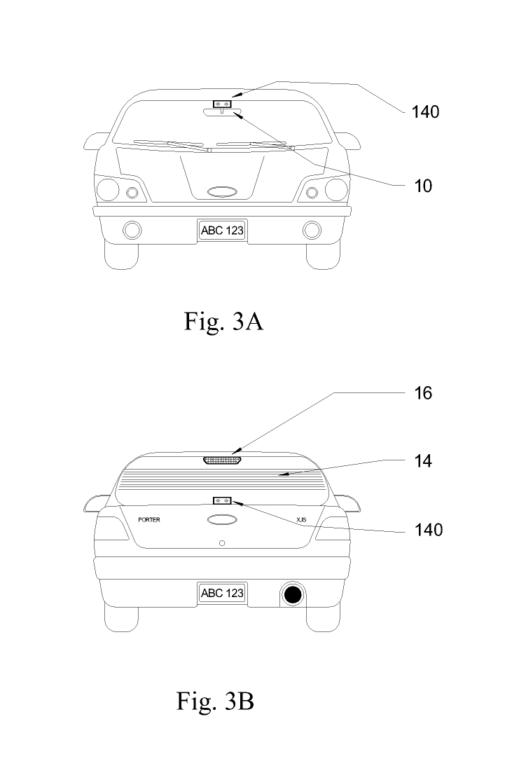

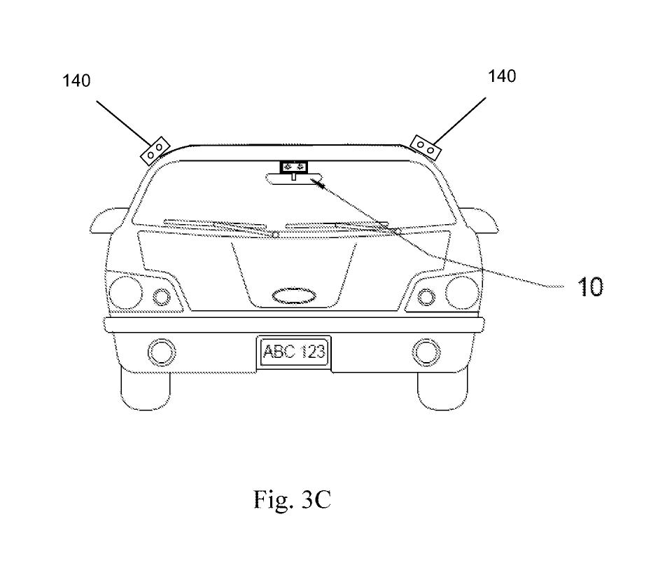

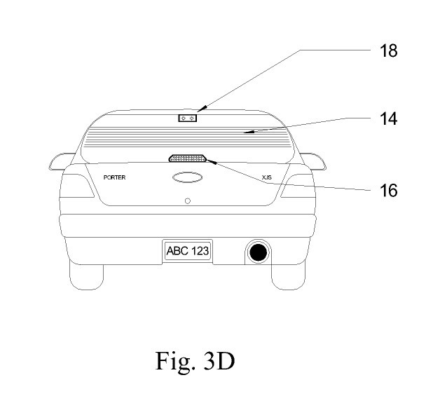

The source of illumination 140 can be located either interiorly or exteriorly of the vehicle body or chassis structure, such that the indicator generated by the source when activated is highly visible and unobstructed when viewed from the exterior of the vehicle. This is particularly advantageous when the vehicle is moving at a high speed. The position of the source of illumination 140 will now be described with reference to FIGS. 3A-3D. However, a person of ordinary skill in the art understands that the suitable location of the source of illumination is not limited to the shown embodiments. Rather, without departing from the invention, the location can be changed and adjusted in view of, for example, the type of vehicle, the make and model of the vehicle, the specific local or state law or regulations, and the like.

FIGS. 3A and 3B, respectively, illustrate front and rear end views of a passenger vehicle, in this instance representing a sedan or coupe, although the invention is also applicable to SUVs, panel trucks and other diverse types of vehicles.

As shown in FIG. 3A, the front windshield has located, interiorly thereof, a rear view mirror 10, the surface of which facing forwardly and outwardly is equipped with one or more sources of illumination 140 for generating indicators indicative of the seatbelts not being properly engaged during the operation of the vehicle. In this instance, the indicators generated by the these sources of illumination can be of different types and colors as mandated by the manufacturer of the vehicle and will remain in an “on” or illuminated condition during the operation of the vehicle as long as the seatbelts are not properly engaged, thereby providing indication to oncoming vehicles, pedestrians, or law enforcement personnel that the seatbelts are not properly deployed. It is also possible that these sources of illumination are mounted on the vehicle body structure externally of the windshield, for example, towards the top of the windshield on the vehicle body or on the exterior surface of the windshield, or at any other location from which the alert lights can be readily viewed from the exterior of the vehicle without any obstruction.

As shown in FIG. 3B representing a perspective view of the rear of the vehicle, the rear window 14 has a third brake light 16 located near the top of the rear window and one or more sources of illumination 140 are located towards the bottom of the window. These sources of illumination can be the same or similar in nature to those mounted at the front of the vehicle, or can be of any other shape or color as mandated by the vehicle manufacturer. These sources of illumination will remain in an activated illuminated condition during the operation of the vehicle as long as the seatbelts are not properly engaged, and provide indication to oncoming vehicles, pedestrians, or law enforcement personnel that the seatbelts are not properly engaged. Furthermore, it should be noted that the sources of illumination shown in FIG. 3A and FIG. 3B, respectively, can be combined to enhance the seatbelt alert lighting. FIG. 1 schematically illustrates the combination of the front end illumination and the rear end illumination.

FIG. 3C illustrates an embodiment, in which one or more sources of illumination are mounted at one side or both sides of the vehicle. FIG. 3D illustrates another embodiment, in which the third brake light 16 is located towards the bottom of the rear window 14 and one or more sources of illumination are located towards the top or upper end of the rear view mirror.

In one embodiment, both a front alert light and a rear alert light, of a high-intensity yellow light, are employed as discussed hereinabove. The front alert light and the rear alert light can be electrically connected to the seatbelt engagement switch 120, which activates the interior seatbelt warning light 160 mounted on the dashboard for providing indications to the driver and/or the passenger(s). Thus, in addition to the front and rear alert lights provided on the vehicle for generating readily visible indicators to outside observers, the additional warning light arranged on the dashboard remains illuminated in the absence of proper seatbelt fastening, such that interior indication and warning as to the failure of the seatbelts can be provided. However, the interior warning light is not considered as providing indicators readily or highly visible to the outside observers. Accordingly, certain locations, such as the dashboard, the ceiling of the vehicle, the inside of the doors of the vehicle, are not suitable for applying the sources of illumination according to the present invention.

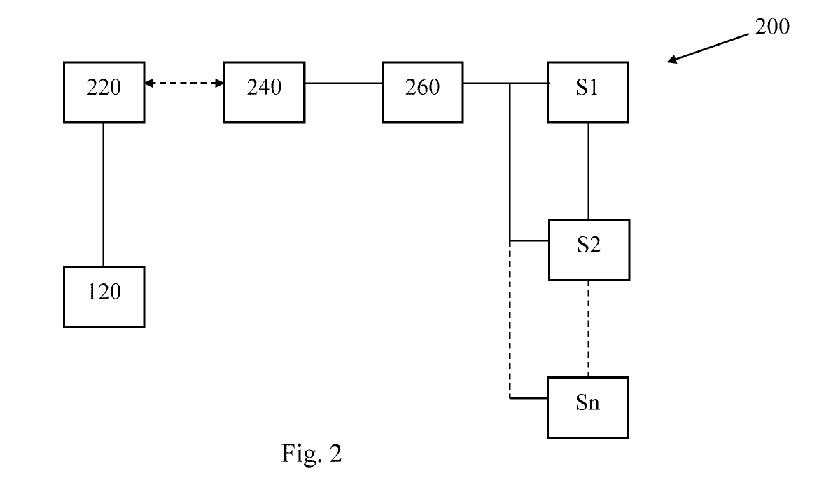

FIG. 2 is a block diagram illustrating a seatbelt alert system 200 according to another embodiment of the present invention. The system 200 includes a signal transmitter 220 in communication with the seatbelt engagement switch 120, for transmitting the first signal and the second signal. The system 200 further includes a signal receiver 240 for receiving the first signal and the second signal from the signal transmitter 220. The system 200 further includes an operation mode switch 260 and one or more sources of illumination S1-Sn, each having an activated mode and a deactivated mode. The operation mode switch 260 is configured to switch the sources illumination S1-Sn from the deactivated mode to the activated mode, responsive to receiving the first signal by the signal receiver 240. The operation mode switch 260 is further configured to switch the sources illumination S1-Sn from the activated mode to the deactivated mode, responsive to receiving the second signal by the signal receiver 240.

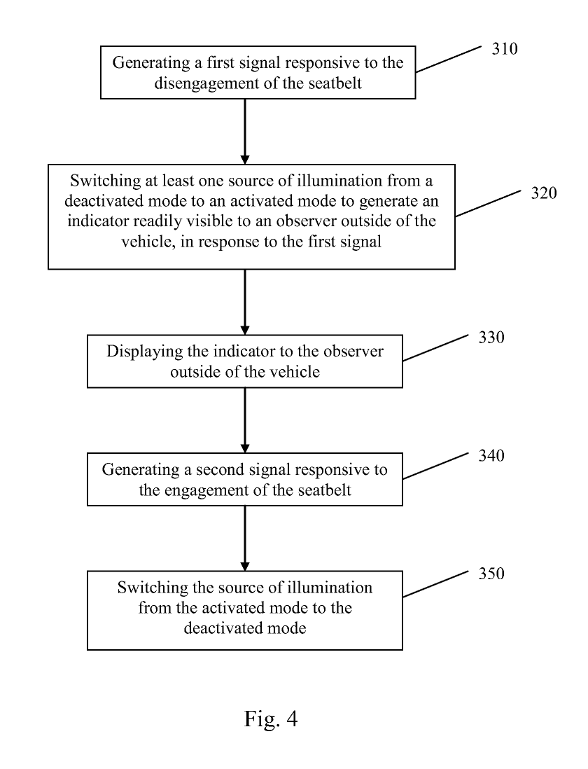

FIG. 4 is a flow chart illustrating a method of indicating disengagement of a seatbelt in a vehicle, according to another aspect of the present invention. At step 310, a first signal responsive to the disengagement of the seatbelt is generated. For example, the first signal can be generated responsive to the disengagement of the seatbelt after the motor vehicle has been operated. At step 320, one or more sources of illumination are switched from a deactivated mode thereof to an activated mode thereof for generating an indicator readily visible to an observer outside of the vehicle, in response to the first signal. At step 330, the indicator is displayed to the observer outside of the vehicle. For example, the indicator is displayed to other motorists, pedestrians and law enforcement personnel. At step 340, a second signal responsive to the engagement of the seatbelt is generated. At step 350, the sources of illumination are switched from the activated mode to the deactivated mode, such that the displaying the indicator readily visible to the observer is terminated.

The step 320 can include sub-steps of receiving the first signal through a signal receiver and switching the sources of illumination from the deactivated mode to the activated mode through an operation mode switch responsive to the receiving the first signal. The step 350 can include sub-steps of receiving the second signal through a signal receiver and switching sources of illumination from the activated mode to the deactivated mode through an operation mode switch responsive to the receiving the second signal. The method can further include the step of mounting the sources of illumination on an exterior of the vehicle or an interior of the vehicle. The method can further include the step of mounting the sources of illumination at a front end, rear end or a side of the vehicle.

The embodiments described above are illustrative examples and it should not be construed that the present disclosure is limited to these particular embodiments. Certain alterations and/or modifications will be apparent to those skilled in the art, in light of the instant disclosure, without departing from the spirit or the scope of the invention. These embodiments are offered as merely illustrative, and not limiting, on the scope of the invention, which is defined solely with reference to the following appended claims.

What is claimed is:

1. A seatbelt alert lighting system used with a vehicle having a seatbelt, the system comprising:
a seatbelt engagement switch configured to generate a first signal responsive to the disengagement of the seatbelt and a second signal responsive to the engagement of the seatbelt; and
at least one source of illumination in communication with the seatbelt engagement switch, the at least one source of illumination having an activated mode and a deactivated mode, in the activated mode the at least one source of illumination generating an indicator readily visible to an observer outside of the vehicle,
wherein the at least one source of illumination is configured to switch from the deactivated mode to the activated mode responsive to the first signal.

2. The seatbelt alert lighting system according to claim 1, wherein the at least one source of illumination is further configured to switch from the activated position to the deactivated position responsive to the second signal.

3. The seatbelt alert lighting system according to claim 1, wherein the seatbelt engagement switch has a first operative position at which the first signal is generated and a second operative position at which the second signal is generated.

4. The seatbelt alert lighting system according to claim 1, further comprising a signal transmitter associated with the seatbelt engagement switch for transmitting the first signal and the second signal and a signal receiver associated with the at least one source of illumination for receiving the first signal and the second signal from the signal transmitter.

5. The seatbelt alert lighting system according to claim 4, further comprising an operation mode switch configured to switch the at least one source of illumination from the deactivated mode to the activated mode responsive to receiving the first signal by the signal receiver and from the activated mode to the deactivated mode responsive to receiving the second signal by the signal receiver.

6. The seatbelt alert lighting system according to claim 1, wherein the at least one source of illumination comprises at least one of an LED, a strobe, an incandescent light and a halogen light.

7. The seatbelt alert lighting system according to claim 1, wherein the visible indicator comprises a visible text indicator.

8. The seatbelt alert lighting system according to claim 1, wherein the at least one source of illumination is mounted on an exterior of the vehicle.

9. The seatbelt alert lighting system according to claim 1, wherein the at least one source of illumination is mounted on an interior of the vehicle.

10. The seatbelt alert lighting system according to claim 1, wherein the at least one source of illumination comprises a first source of illumination mounted on a front end of the vehicle and a second source of illumination mounted on a rear end of the vehicle.

11. A method of indicating disengagement of a seatbelt in a vehicle, comprising:
generating a first signal responsive to the disengagement of the seatbelt;
switching at least one source of illumination from a deactivated mode thereof to an activated mode thereof, for generating an indicator readily visible to an observer outside of the vehicle responsive to the first signal; and
displaying the indicator to the observer outside of the vehicle.

12. The method of claim 11, further comprising:
generating a second signal responsive to the engagement of the seatbelt; and
switching the at least one source of illumination from the activated mode to the deactivated mode such that the displaying the indicator readily visible to the observer is terminated.

13. The method of claim 11, further comprising:
receiving the first signal through a signal receiver; and
switching the at least one source of illumination from the deactivated mode to the activated mode through an operation mode switch responsive to the receiving the first signal.

14. The method of claim 12, further comprising:
receiving the second signal through a signal receiver; and
switching the at least one source of illumination from the activated mode to the deactivated mode through an operation mode switch responsive to the receiving the second signal.

15. The method of claim 11, wherein the switching the at least one source of illumination from the deactivated mode to the activated mode for generating the indicator comprises switching the at least one source of illumination from the deactivated mode to the activated mode for generating a visible text indicator.

16. The method of claim 11, further comprising mounting the at least one source of illumination on an exterior of the vehicle.

17. The method of claim 11, further comprising mounting the at least one source of illumination on an interior of the vehicle.

18. The method of claim 11, further comprising mounting a first source of illumination mounted on a front end of the vehicle and a second source of illumination mounted on a rear end of the vehicle.
